(19) United States
(12) Patent Application Publication
(10) Pub. No.: US 2020/0077600 A1
(43) Pub. Date: Mar. 12, 2020

(54) TRAINING SUPPORT FOR BUSHY PLANT GROWTH

(71) Applicants: Earl F. Shemwell, Maple City, MI (US); Carl S. Shemwell, Traverse City, MI (US)

(72) Inventors: Earl F. Shemwell, Maple City, MI (US); Carl S. Shemwell, Traverse City, MI (US)

(21) Appl. No.: 16/563,841

(22) Filed: Sep. 7, 2019

Related U.S. Application Data
(60) Provisional application No. 62/728,198, filed on Sep. 7, 2018.

(51) Int. Cl. A01G 9/20; A01G 9/12

(52) U.S. Cl. CPC A01G 9/20; A01G 9/122

(57) ABSTRACT

A plant training support comprising a central stem-supported vertical rod and a horizontal ring-like frame at an upper end of the central rod, the length of the central rod and the height of the ring being higher than an expected maximum height for a particular species or variety of a plant. A plurality of filaments are secured at their upper ends at spaced locations around the ring, with their lower ends being above the lower end of the rod. The training support is inserted or secured in a growing medium next to a plant, with the plant stem secured to the central rod, and with lower ends of the filaments secured in gentle tension to upper ends of the branches of the plant.

### RELATED APPLICATIONS/PRIORITY BENEFIT CLAIM

This application claims the benefit of U.S. Provisional Application No. 62/728,198, filed Sep. 7, 2018 by the same inventors (Shemwell and Shemwell), the entirety of which provisional application is hereby incorporated by reference.

### FIELD

The subject matter of the present application is in the field of devices for supporting and training the growth of garden plants.

### BACKGROUND

Devices for training and supporting the branches of bushy garden and other plants are known. Tomatoes are a classic example, but flowering bushes, commercially grown marijuana plants, and other bushy plants can benefit from a combination of circumferential stabilization and directional growth training to form a well-shaped plant with good spacing between the branches for air, light, and leaf/flower/fruit growth.

U.S. Pat. No. 2,173,217 to Thomsen discloses a support for plants comprising a wire spiral at the top end of a vertical stem.

U.S. Pat. No. 1,556,373 to Thoeni discloses a plant support comprising a vertical anchor rod with a vertically adjustable frame mounted on the rod. The frame comprises an larger diameter main ring connected by spokes to a hub that is vertically adjustable on the rod. For plants with longer central stems or branches, a smaller diameter upper ring can be supported above the main ring via a vertical support connected to the main ring's hub. The foliage and blooms of the plant are adapted to be surrounded and stabilized by the ring(s).

U.S. Pat. No. 6,810,618 to Hauser discloses a wheel-shaped frame on the end of a vertical rod for supporting a flexible plant covering, such as a bird-excluding net or a thermal blanket, to enclose and cover a plant.

### BRIEF SUMMARY

The present invention comprises a plant training support comprising a vertical rod, stake, or similar vertical support member (hereafter generally “rod”) with a fixed, non-rotating “ring” secured at an upper end of the rod by a plurality of substantially horizontal spokes. The vertical rod is secured in a growing medium alongside the main stem of a plant with the stem secured thereto. The height of the ring on the vertical rod is selected to be higher than both the initial plant height and a maximum desired plant height, and the diameter of the ring is selected to be greater than the initial plant diameter and equal to or greater than the desired maximum plant diameter. “Upper” end of the rod means above the plant.

The invention further comprises a plurality of filaments (string, wire, cord, etc.) spaced around the circumference of the ring, the filaments individually secured at their upper ends to the ring and individually secured at their lower ends to upper ends of a plurality of individual branches in tension. The filaments exert a gentle but substantially continuous tension on the upper ends of their respective branches to train their growth in a desired upward direction.

When the branches grow to the point that tension on their filaments is reduced, the filaments are shortened or tightened to restore the growth-directing tension.

“Ring” is used herein to include a variety of substantially horizontal planar shapes having a perimeter structural member such as a rod or wire or tube spaced radially from the central support rod. Circular shapes, rectangular shapes, and other polygonal shapes are possible. “Branch” includes branches, secondary stems, spurs, vines, shoots, and any other trainable plant portion growing from the main vertical trunk or stem, depending on the type of plant being supported and trained.

These and other features and advantages of the invention will become apparent from the detailed description below, in light of the accompanying drawings.

### BRIEF DESCRIPTION OF THE DRAWINGS

FIG. 1 is a perspective view of an example plant training support according to the invention.

FIG. 2 is a top plan view of the plant training support of FIG. 1.

FIG. 3 is a top plan view of a first alternately-shaped plant training support according to the invention.

FIG. 4 is a top plan view of a second alternately-shaped plant training support according to the invention.

FIG. 5 is a top plan view of a third alternately-shaped plant training support according to the invention.

FIG. 6 is similar to FIG. 1, but shows the plant-training support modified with a stabilizing gusset associated with one of the spokes.

FIG. 6A is an exploded view of the plant-training support of FIG. 6.

FIG. 7 is a top plan view of the plant training support of FIG. 6, with the stabilizing gusset shown in hidden lines relative to the vertical rod.

### DETAILED DESCRIPTION

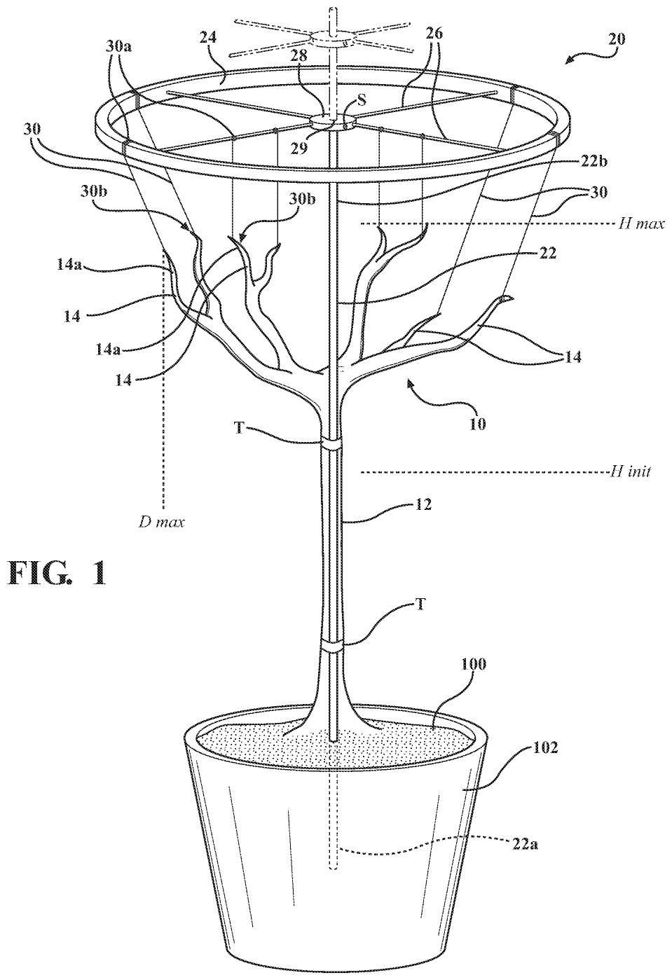

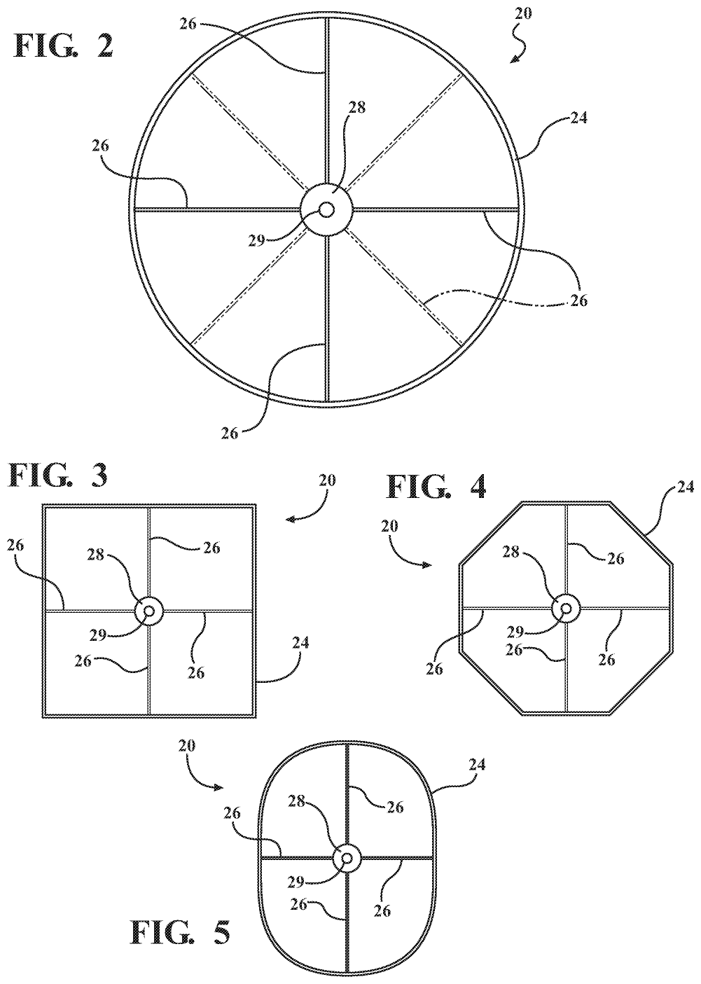

Referring first to FIG. 1, a plant training support 20 is shown in exemplary form in combination with a potted plant 10 in order to teach how to make and use the claimed invention.

Plant 10 is “potted” or otherwise planted to grow in a suitable growing medium 100, which may be open ground, a raised bed, a soil-filled pot, a hydroponic fluid container, or any other known type of growing medium in which a lower end of the plant training support 20 can be fixed or secured. Plant 10 includes a main, substantially vertical stem or trunk or leader or equivalent central growth structure (hereafter “stem”) know by various names to those skilled in the art, and a plurality of secondary branches 14 with tips or upper ends 14a.

Plant training support 20 comprises a central rod 22 whose lower end 22a is secured in the growing medium or to its container, in the illustrated example by inserting it firmly into dirt 100 contained in pot 102. Where the growing medium does not accommodate a simple insertion to support the rod 22 vertically, anchoring or fastening means such as but not limited to clips or a weighted base could be attached to or formed on the lower end 22a to secure the rod to the growing medium or its container.

Central rod 22 is arranged vertically adjacent the main vertical stem 14 of plant 10, generally parallel thereto, and stem 14 is secured to rod 22 at one or more locations T along its length with wire, clips, twine, ties, tape, or other known means in a manner that still allows proper growth and nutrient supply. It will be understood that rod 22 may take different cross-sectional shapes, and is not limited to a cylindrical member as shown.

Plant training support 20 further includes a fixed, non-rotating “ring” or frame 24 supported by rod 22 at an upper end of the rod, the ring secured to the central rod by a plurality of substantially horizontal support bars or spokes 26 connected directly to rod 22 or via a reinforced hub 28. Ring 24 may be formed integrally with central rod 22, or it may be formed separately and attached to the upper end of the rod in removable (preferred, illustrated) or permanent fashion. In the illustrated example, the preferred material for rod 22 and ring 24 (including the spokes 26 and hub 28) is a durable rigid plastic material, although other materials are possible. Ring 24 is fixed to the upper end 22b of rod 22 in a non-rotating manner. While ring 24 is illustrated in the example as topping the uppermost tip of the rod 22, the ring 24 may be located anywhere along the upper end of the rod 22, i.e. a portion of the rod may extend above the ring, provided the ring is higher than the plant being supported. The ring height may also be adjustable, as shown in phantom in FIG. 1, for example by making the ring hub 28 slidably adjustable along the rod via an optional hole 29 through which the upper end of rod 22 can extend as illustrated in phantom, and capable of being fixed in place at different heights with a set screw such as S or other adjustable connection, or by making the rod adjustable in length using known telescoping mechanisms. And while ring 24 and spokes 26 are shown in a preferred flat, planar, horizontal ring configuration when attached to rod 22, portions of the ring and/or spokes may be angled from horizontal provided they are more horizontal than vertical when attached to the rod.

Plant training support 20 is combined with plant 10 while the plant is relatively young and expected to increase significantly in height and diameter and general growth. The height of rod 22 and the vertical location of ring 24 on the rod may be selected or adjusted initially to be higher than both the initial height (Hinit) and the expected maximum height (Hmax) of the particular plant species, which height will be known to those skilled in the art of horticulture, or (where the ring height is adjustable) the height of the ring 24 may be initially set and later adjusted to be maintained above the initial and later heights of the plant 10 as the plant grows. The diameter or width of ring 24 is selected for a desired spread or diameter of the collective branch growth, which may vary by personal preference or recommended ideals for particular plants, but will generally be greater than the diameter of the young plant when the plant and training support are initially combined, and equal to or greater than the expected maximum diameter (Dmax) of the mature plant.

A plurality of individual filaments 30 is secured to ring 24 at their upper ends 30a at spaced locations around ring 24, the manner of securing determined by the nature of the filament (wire, twine/string, fishing line, light cord, etc.). For example, knotting, twisting, and loops are all possible means for securing the filaments 30 to the ring 24, depending on the filament material. Filaments 30 may be connected directly to ring 24, or they may be connected via intermediate connectors such as clips or hooks.

Filaments 30 have a free length less than the length of central rod 22 between the surface of the growing medium 100 and ring 24, such that their lower ends 30b remain above the surface of the growing medium. In particular, the free length of filaments 30 approximates the distance between the ring and the tip or upper end 14a of the nearest branch 14 at the time of initial attachment to the young plant's branches when the plant is at its starting or initial height (Hinit). The lower end 30b of each filament 30 is secured to a respective nearest upper end 14a of an adjacent branch, using any of the foregoing connecting methods depending on the nature of the filament and the relative robustness of the upper end 14a of the branch. Once the lower ends 30b of filaments 30 are connected to the upper ends 14a of their respective branches, their length can be adjusted to place a gentle tension on the upper ends of the branches to urge or train them to grow toward the location on ring 24 where the upper ends 30a of their respective filaments 30 are secured. Some filaments 30 may also be attached to the plant's branches 14 at places other than their upper ends 14a, if desired, for additional support.

As the plant 10 grows, and the upper ends of the branches 14 extend upwardly and outwardly toward ring 24 along the axes of their respective filaments 30, the filaments are progressively shortened in length to maintain the desired training tension. Once the maximum plant height or growth is achieved, the shortened filaments can be left secured between ring 24 and branches 14 to help support and maintain the shape and branch spacing of the plant.

While many or most branches will preferably be secured to the outer ring 24 of the support 20, it is also possible to secure interior branches 14 to spokes 26 at various locations inside the ring.

FIGS. 3, 4 and 5 show training supports 20 similar to that in FIG. 1, but with differently shaped outer rings 24. Other shapes are possible, as well. The number of spokes 26 may also vary for considerations of strength and the number of interior branches 14 which might need to be tensioned by filaments 30 inwardly of the outer diameter of ring 24.

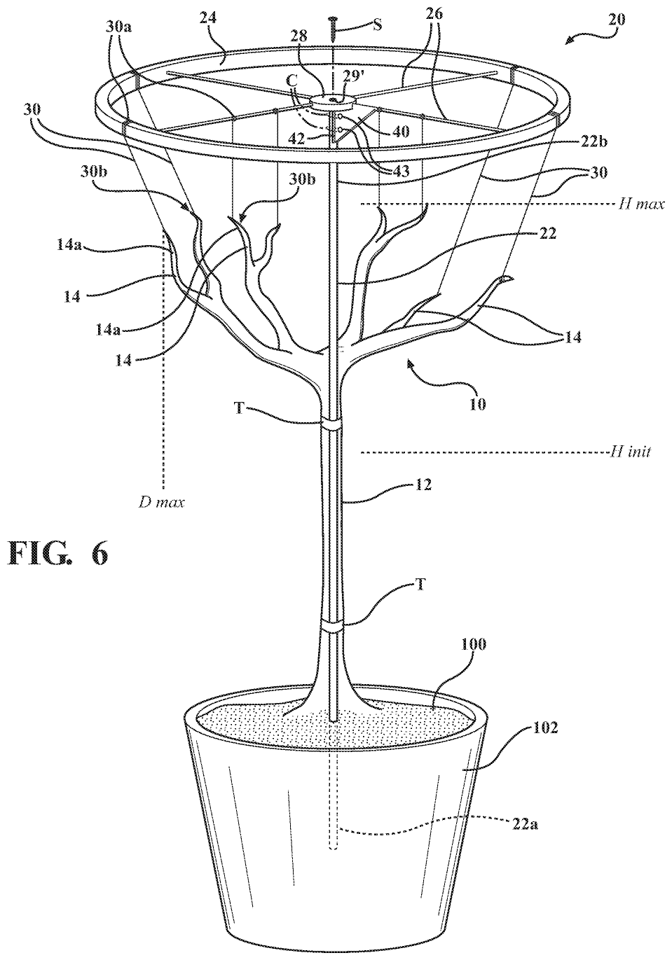

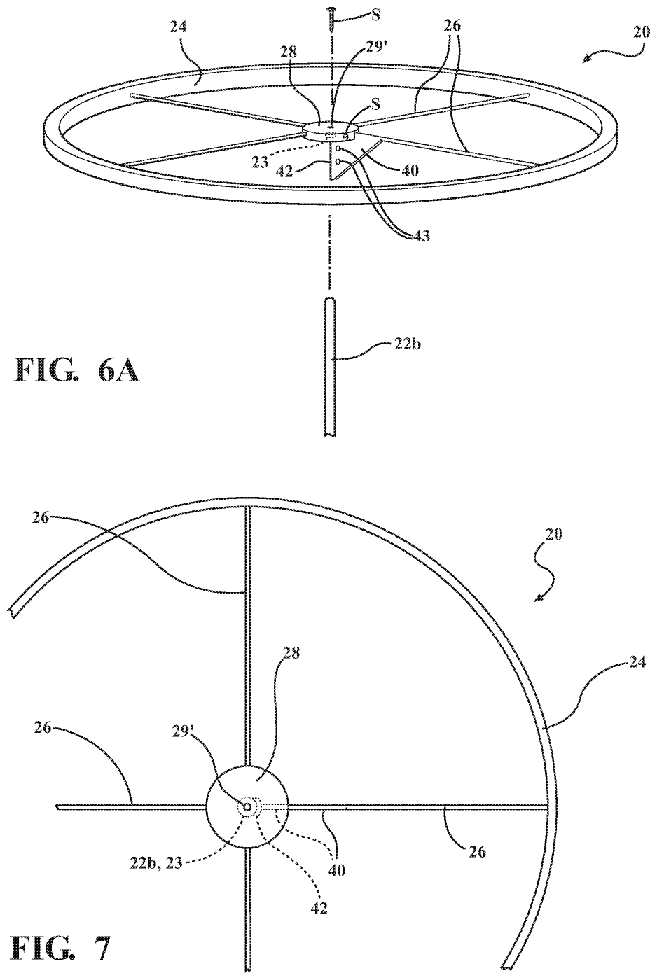

FIGS. 6, 6A and 7 show a modified support 20, in which the hub 28 has been modified with a smaller central hole 29′ of smaller diameter than the diameter of the upper end 22b of rod 22, and (depending on the thickness of hub 28) an optional countersunk lower blind bore 23 of a diameter sufficient to mate with the upper end of the rod therein. Ring 24 is secured to the upper end or tip of rod 22 with a screw, nail, bolt or similar fastener S inserted through hole 29′ into the tip of rod 22 to secure the ring to the rod in a fixed manner. Ring 24 has been further modified with a stabilizing fin-like gusset 40 associated with one of spokes 26 to extend from the spoke (and preferably also from the underside of hub 29) to engage the side of rod 22 at a widened inner face 42 along the gusset's vertical edge. In the illustrated example, gusset 40 is a molded plastic feature integrally formed with the spoke 26 and/or hub 28, preferably as an extension of both as illustrated, and preferably in the form of a triangle although other shapes are possible. Gusset 40 could also be formed separately and affixed to the underside of spoke 26 and/or hub 28. Hub 24 may take the form of a relatively flat washer (e.g. plastic or metal) with a thickness similar to that of the spokes, in which case the countersunk lower bore 23 may be omitted. Depending on the manner of connection of the spokes 26 to hub 24, i.e. mechanically attached thereto or integrally formed or molded therewith, gusset 40 may be connected to just the spoke and simply extend underneath the hub to a position aligned for abutting engagement with rod 22 when the rod is assembled to the ring.

As best shown in FIGS. 6A and 7, widened inner face 42 of gusset 40 is formed as a widened flange generally perpendicular to the plane or main body of gusset 40, preferably with a concave curved face suited for engaging the rounded surface of a cylindrical rod 22. Inner face 42 could be flat, as well, which might be preferred for some shapes of rod 22, although a curved inner face 42 as shown will also stabilize against a flat rod surface or a rod surface of different radius of curvature with a spaced rail effect.

While inner face 42 can be formed as a flange substantially perpendicular to the main triangular body of the generally flat and wider than the substantially constant thickness of the main body of gusset 40, inner face 42 could also be formed by an increasing thickness of the body of gusset 40 to a widest thickness at inner face 42, like a wedge.

Further shown in FIGS. 6 and 6A, gusset 40 preferably includes one or more openings 43 adjacent inner face 42. Openings 43 are configured to receive cable ties or similar wraparound type fasteners C (wire, twine, clips) therethrough and around the rod 22 to more securely lock and stabilize the gusset 40 and ring 24 to rod 22 and to hold inner face 42 under tension against the rod surface in vertical alignment therewith.

It will finally be understood that the disclosed embodiments represent presently preferred examples of how to make and use the invention, but are intended to enable rather than limit the invention. Variations and modifications of the illustrated examples in the foregoing written specification and drawings may be possible without departing from the scope of the invention. It should further be understood that to the extent the term “invention” is used in the written specification, it is not to be construed as a limiting term as to number of claimed or disclosed inventions or discoveries or the scope of any such invention or discovery, but as a term which has long been used to describe new and useful improvements in science and the useful arts. The scope of the invention supported by the above disclosure should accordingly be construed within the scope of what it teaches and suggests to those skilled in the art, and within the scope of any claims that the above disclosure supports in this application or in any other application claiming priority to this application.

1. A plant training support comprising:
a vertical rod with a non-rotating ring comprising a radially outer ring portion and a plurality of substantially horizontal spokes extending radially inward toward a center of the ring, the ring secured to an upper end of the rod by the spokes, the lower end of the rod configured to be secured in a growing medium alongside a main vertical stem of a plant and to have the stem secured thereto; wherein,
a height of the ring on the rod is selected or adjusted to be higher than both an initial plant height and a maximum plant height; further wherein,
a plurality of filaments are individually secured at upper ends thereof at spaced locations around the outer ring portion and on the spokes, the filaments having a free length less than the height of the ring on the rod so that their lower ends are above the lower end of the rod.

2. The plant training support of claim 1, wherein the spokes are connected at the center to a hub, and the hub is connected to the rod.

3. The plant training support of claim 1, wherein the ring is adjustably secured to the rod with a vertical sliding fit to adjust the height of the ring on the rod.

4. The plant training support of claim 1, further including a gusset extending between one of the spokes and the rod, the gusset comprising a main body and a vertical rod-engaging edge having an inner face substantially perpendicular to the gusset main body and further having a width greater than a thickness of the gusset main body, the inner face of the gusset abutting the rod.

5. The plant training support of claim 4, wherein the inner face of the gusset abuts the rod with a sliding engagement.

6. The plant training support of claim 4, wherein the inner face of the gusset has a concave curvature.

7. The plant training support of claim 4, wherein the gusset main body comprises at least one opening for receiving a supplemental wraparound fastener therethrough for tensioning the gusset inner face against the rod.

8. In combination with the plant training support of claim 1, a plant in a growing medium, the lower end of the 1 rod of the plant training support secured in the growing medium or a container thereof, and an intermediate portion of the rod secured to a vertical main stem of the plant generally parallel thereto, and further wherein the lower ends of the filaments are individually secured to upper ends of a plurality of individual branches of the plant in tension.
